(19) United States
(12) Patent Application Publication
(10) Pub. No.: US 2007/0258875 A1
(43) Pub. Date: Nov. 8, 2007

(54) Mixed Rare Earth Oxide, Mixed Rare Earth Fluoride, Cerium-Based Abrasive Using the Materials and Production Processes Thereof

(75) Inventors: Tadashi Hiraiwa, Fukushima (JP); Tomoyuki Masuda, Fukushima (JP); Naoki Bessho, Fukushima (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/661,549

(22) PCT Filed: Sep. 2, 2005
(86) PCT No.: PCT/JP05/16575

§ 371 Date: Mar. 1, 2007

Related U.S. Application Data
(60) Provisional application No. 60/608,877, filed on Sep. 13, 2004.

(30) Foreign Application Priority Data
Sep. 3, 2004 (JP) 2004-256947

(51) Int. Cl. C01F 17/00

(52) U.S. Cl. 423/21.1

(57) ABSTRACT

The present invention provides a mixed rare earth oxide for the production of a cerium-based abrasive, in which the ignition loss after heating at a temperature of 1,000° C. for 1 hour is 0.5 mass % or less on the dry mass basis and the crystallite diameter is from 200 to 400 Å; a mixed rare earth fluoride for the production of a cerium-based abrasive, in which the ignition loss is from 3 to 15% on the dry mass basis; a process for producing a cerium-based abrasive from these mixed rare earth oxide or mixed rare earth fluoride; and a cerium-based abrasive produced by using these mixed rare earth oxide or mixed rare earth fluoride.

### CROSS REFERENCE TO RELATED APPLICATION

This application is an application filed under 35 U.S.C. §111(a) claiming benefit pursuant to 35 U.S.C. §119(e) of the filing date of Provisional Application 60/608,877, filed on Sep. 13, 2004, pursuant to 35 U.S.C. §111(b).

### TECHNICAL FIELD

The present invention relates to a cerium-based abrasive for use in the polishing of a vitreous substrate such as glass substrate used for an optical lens, a liquid crystal panel, a hard disk, a specific frequency wave cutting filter or the like; raw materials of the abrasive; and production processes thereof. In particular, the present invention relates to a cerium-based abrasive for use in the finish polishing of a high-precision glass substrate such as a hard disk substrate and a glass substrate for a liquid crystal panel; raw materials of the abrasive; and production processes thereof.

### Related Art

Recently, a glass material is being variously used and, in some of these uses, surface polishing is necessary. For example, in the case of an optical lens, a precision giving a mirror surface is required. Also, a glass substrate for an optical disk or a magnetic disk, a glass substrate for a liquid crystal display such as thin-film transistor (TFT)-type LCD and super-twisted nematic (STN)-type LCD, a color filter for a liquid crystal televisions, and a glass substrate for an LSI photomask are required to have flatness, small surface roughness and no defects and, therefore, high-precision surface polishing is required.

The glass substrate for a liquid crystal display is required to have high heat resistance so as to withstand the high temperature of a heat treatment in a later step and, also, the glass substrate is required to be thin for the purpose of weight reduction. Furthermore, with the recent abrupt increase in the demand for liquid crystal televisions, the growth in size of the television is accelerating. Also, the requirements regarding the glass substrate for a magnetic disk are becoming more severe and include thickness small enough to reduce weight and mechanical properties (particularly, rigidity) high enough to endure rolling of the disk at high-speed rotation.

On the other hand, in a large projection television, as the substrate area is relatively small despite using the same number of pixels as that of a large liquid crystal television, a device such as high-temperature polysilicon TFT is employed and a hard quartz glass or the like is used for the substrate.

In order to satisfy the requirements regarding small thickness and high mechanical property, the glass is made harder by improving its chemical composition or production process and in turn, suffers from poor processability.

As for the abrasive used in the surface polishing of a glass substrate, an abrasive mainly comprising silicon dioxide, an iron oxide, a zirconium oxide or a rare earth oxide is used. An abrasive mainly comprising a rare earth oxide, particularly cerium oxide, is considered to be advantageous because the polishing rate is by far higher than that of silicon dioxide. Such an abrasive is generally used by dispersing abrasive grains in a liquid such as water.

However, when a conventional cerium-based abrasive is used under conventional polishing conditions, the processing rate is low and moreover, there are problems that the polishing rate extremely decreases due to clogging of the polishing pad, that the dressing of polishing pad or the exchanging of the polishing slurry must be done frequently and that the productivity is seriously worsened. Accordingly, an abrasive and a slurry thereof, which can ensure a high-precision surface polishing performance and a high polishing rate and can reduce the occurrence of clogging and be stably used over a long period of time, are in demand.

The polishing mechanism of the cerium-based abrasive is not fully elucidated, but it has been phenomenologically confirmed that the polishing process proceeds by a composite effect of a chemical effect by the cerium oxide on glass and a mechanical effect attributable to the hardness of the cerium oxide particle itself.

However, a glass substrate mainly comprising aluminosiliate or a crystallized glass substrate mainly comprising lithium silicate has an excellent chemical resistance and therefore, the chemical effect by the cerium-based abrasive is not satisfactorily exerted. Furthermore, such a glass substrate (a material to be processed) is hard and readily causes crushing of the abrasive particles. As a result, the mechanical effect on glass cannot be sufficiently maintained and the processing rate decreases in a very short time. This tendency is particularly pronounced on a large substrate, the demand for which has abruptly increased. The cerium-based abrasive is required to maintain a high processing rate over a long period of time.

In order to maintain the mechanical effect over a long period of time, it is possible to add an abrasive grain having a hardness equal to or greater than that of a material to be processed, such as calcium fluoride, alumina and diamond abrasive grain, into the abrasive composition (Japanese Unexamined Patent Publication (Kokai) No. 8-253763). However, in this case, the concentration of the cerium oxide particle is relatively decreased and the chemical effect is not satisfactory. Also, due to the powder particle having a hardness equal to or greater than that of a material to be processed, defects such as pits and scratches are generated on the glass surface (surface of the material to be processed).

In recent years, a mixed rare earth carbonate (Japanese Unexamined Patent Publication (Kokai) No. 2004-2870) or a mixed rare earth oxide obtained by firing a mixed rare earth carbonate (Japanese Unexamined Patent Publication (Kokai) No. 2002-309236) has been used as a raw material of the cerium-based abrasive. In the case of using a mixed rare earth oxide, for the purpose of attaining uniform progress of a reaction with fluorine, which is indispensable for achieving a high polishing rate, it is considered, for example, to leave a partially unoxidized carbonate and prevent production of an excessively fired mixed rare earth oxide particle, or to mix it with a mixed rare earth carbonate. However, in a process using such a raw material, the carbonic acid is lost as a gas at the final firing of the process of producing a cerium-based abrasive. Thus, this process does not necessarily ensure low material cost and high firing efficiency. Furthermore, if the firing degree of the skeletal rare earth oxide is low, the finally obtained cerium-based abrasive particles become non-uniform in hardness and this gives rise to a problem in that, for example, scratches are generated on the polished glass surface or the polishing rate decreases in a very short time. Particularly, in the case of a hard glass substrate, an extreme reduction in the polishing rate is fatal.

In order to solve these problems, in Japanese Unexamined Patent Publication (Kokai) No. 2001-365039, a mixed rare earth fluoride is added to the mixed rare earth oxide, and the resulted mixture is subjected to wet grinding, drying, firing, cracking and classification to obtain a cerium-based abrasive. Also, Japanese Unexamined Patent Publication (Kokai) No. 2002-97457 and 2002-97458 each discloses a method of evaluating a fluorine-containing cerium-based abrasive by using X-ray diffraction.

### DISCLOSURE OF THE INVENTION

In the present invention, the problems in conventional techniques of Japanese Unexamined Patent Publication (Kokai) No. 8-253763, 2004-2870 and 2002-309236 are solved and the cerium-based abrasive of Japanese Unexamined Patent Publication (Kokai) No. 2001-365039 is improved. That is, one object of the present invention is to provide raw materials of a cerium-based abrasive, which are inexpensive and ensure a good production efficiency. Another object of the present invention is to provide a process for producing a cerium-based abrasive by using these raw materials, in which the cerium-based abrasive can maintain the initial polishing rate over a long period of time for a glass substrate difficult to polish at a high rate, such as hard glass substrate, or for a glass substrate difficult to polish to give a flat polished surface, such as large glass substrate, and preferably can enhance the quality of the polished substrate such as glass without causing surface defects such as pits and scratches thereon.

The present invention is as follows. (1) A mixed rare earth oxide for the production of a cerium-based abrasive, wherein the ignition loss after heating at a temperature of 1,000° C. for 1 hour is 0.5 mass % or less on the dry mass basis, and the crystallite diameter calculated from a half-value width of the maximum peak at 2θ=10 to 70 degrees in X-ray diffraction using Cu—Kα1 radiation according to the Scherrer's equation is from 200 to 400 Å.

(2) The mixed rare earth oxide as described in (1) above, wherein the crystallite diameter is from 200 to 300 Å.

(3) A process for producing the mixed rare earth oxide described in (1) or (2) above, wherein the process comprises firing a mixed rare earth carbonate at a temperature of 850 to 1,100° C. for 1 to 10 hours.

(4) A mixed rare earth fluoride for the production of a cerium-based abrasive, wherein the ignition loss after heating at a temperature of 1,000° C. for 1 hour is from 3 to 15% on the dry mass basis.

(5) The mixed rare earth fluoride as described in (4) above, wherein the maximum particle diameter as measured by the laser diffraction/scattering method is 100 μm or less.

(6) A process for producing the mixed rare earth fluoride described in (4) or (5) above, wherein the process comprises fluorinating a mixed rare earth compound slurry with a fluorine compound to cause precipitation of a mixed rare earth fluoride and drying the precipitate at a temperature of 400° C. or less.

(7) A process for producing a cerium-based abrasive, wherein the process comprises mixing the mixed rare earth oxide described in (1) or (2) above and a mixed rare earth fluoride, and subjecting the resulted mixture to grinding, drying, firing, cracking and classification.

(8) A process for producing a cerium-based abrasive, wherein the process comprises mixing a mixed rare earth oxide and the mixed rare earth fluoride described in (4) or (5) above, and subjecting the resulted mixture to grinding, drying, firing, cracking and classification.

(9) A process for producing a cerium-based abrasive, wherein the process comprises mixing the mixed rare earth oxide described in (1) or (2) above and the mixed rare earth fluoride described in (4) or (5) above, and subjecting the resulted mixture to grinding, drying, firing, cracking and classification.

(10) The process for producing a cerium-based abrasive as described in any one of claims (7) to (9) above, wherein the mixed rare earth oxide and the mixed rare earth fluoride are mixed at a ratio of 90:10 to 65:35 in terms of the mass ratio.

(11) The process for producing a cerium-based abrasive as described in any one of claims (7) to (10) above, wherein a dispersant is added in at least either one step of the mixing and the grinding.

(12) The process for producing a cerium-based abrasive as described in any one of (7) to (11) above, wherein the firing is performed at a temperature of 750 to 1,100° C. with an oxygen concentration of 10 to 20%.

(13) A cerium-based abrasive produced by using the mixed rare earth oxide described in (1) or (2) above and the mixed rare earth fluoride described in (4) or (5) above.

(14) A cerium-based abrasive produced by the process described in any one of (7) to (12) above.

(15) A process for polishing a glass substrate, wherein a glass substrate is polished by using the cerium-based abrasive described in (13) or (14) above.

(16) A process for producing a glass substrate, comprising a step of polishing the glass substrate by the process described in (15) above.

(17) A process for producing a liquid crystal panel, a hard disk, a filter for cutting a specific-frequency wave or an optical lens, wherein the process comprises a step of polishing a glass substrate by the process described in (15) above.

When the mixed rare earth oxide and the mixed rare earth fluoride of the present invention are used, the skeleton of the cerium-based abrasive can be made firm and, also, the reaction between the mixed rare earth oxide and mixed rare earth fluoride for producing a mixed rare earth oxy-fluoride can be effectively performed. Accordingly, when a cerium-based abrasive obtained by the production process of the present invention is used, a high polishing rate can be maintained over a long period of time and at the same time, a polished surface having few scratches, a small surface roughness and good quality can be obtained.

Furthermore, when the mixed rare earth oxide and the mixed rare earth fluoride of the present invention are used, a good-quality cerium-based abrasive can be obtained by a simple solid phase reaction. Accordingly, a cerium-based abrasive can be obtained with high productive efficiency at a low production cost.

### BEST MODE FOR CARRYING OUT THE INVENTION The present invention is described in detail below.

(Mixed Rare Earth Oxide)

The mixed rare earth oxide and, particularly, the particulate mixed rare earth oxide, of the present invention for the production of a cerium-based abrasive is a mixed oxide of rare earths, mainly cerium (Ce), lanthanum (La), praseodymium (Pr) and neodymium (Nd), and can be produced from a natural ore (rare earth concentrate) rich in these rare earth elements.

In the mixed rare earth oxide of the present invention, the total rare earth content is, in terms of the oxide, preferably more than 95 mass %, more preferably about 98 mass %. Also, cerium preferably occupies, in terms of the oxide, 40 mass % or more, more preferably 60 mass % or more, based on all rare earths contained.

In the case of producing the mixed rare earth oxide of the present invention from a rare earth ore, the ore is roasted together with sulfuric acid to produce a sulfate, this sulfate is dissolved in water, and components other than rare earths, such as alkali metal, alkaline earth metal and radioactive material, are removed as insoluble matters. The residue is formed into a mixed rare earth hydroxide with a base such as sodium hydroxide, and the mixed rare earth hydroxide is dissolved with hydrochloric acid to produce a mixed rare earth chloride solution. From this mixed rare earth chloride solution, a carbonate is produced by adding sodium carbonate, ammonium bicarbonate or the like, or an oxalate is produced by adding an oxalic acid. The obtained salt is used as the raw material of the mixed rare earth oxide of the present invention.

It is also possible to chemically separate and remove, out of rare earth components, medium and heavy rare earths and Nd from the mixed rare earth chloride solution by a solvent extraction method. In this case, a carbonate or an oxalate is obtained by adding sodium carbonate, ammonium bicarbonate, oxalic acid or the like, and the resulting mixed light rare earth salt is used as the raw material of the mixed rare earth oxide of the present invention. The medium and heavy rare earths as used herein mean rare earths having an atomic number larger than Pm (promethium).

In the mixed light rare earth compound after removing the medium and heavy rare earths by the solvent extraction method, for example, the content of all rare earths is from 45 to 55 mass % in terms of the oxide, the cerium content in all rare earths is from 45 to 75 mass % in terms of the oxide, and the content of non-rare earth components excluding carbonic acid is 1.5 mass % or less, with the balance being carbonic acid.

In the case of using a complex mixed ore of bastnasite and monazite, it is common to chemically separate and remove the components other than rare earths, such as alkali metal, alkaline earth metal and radioactive material, by the above-described sulfuric acid roasting of the rare earth concentrate. In the case of using a bastnasite single ore, as the composition is relatively simple, this separation and removal is generally achieved by the separation method of dissolving the rare earth components in a sulfuric acid or a concentrated hydrochloric acid. The chemical separation and removal of rare earth components of medium and heavy rare earths and Nd is generally performed by a solvent extraction method.

The resulting mixed light rare earth compound may be fired at a temperature of 850 to 1,100° C. to obtain the mixed rare earth oxide of the present invention. However, specific firing conditions are dependent on the mixed rare earth compound used and should be decided to obtain the mixed rare earth oxide of the present invention.

The raw material for use in the present invention cannot be quantitatively expressed for the hardness of the particle because the particle is generally very small and the hardness of the particle itself is difficult to measure. Therefore, an ignition loss and a crystalline diameter are used as an indirect measure for expressing the hardness of the particle.

The mixed rare earth oxide of the present invention for the production of a cerium-based abrasive is a mixed rare earth oxide adjusted to have an ignition loss of 0.5 mass % or less when heated at a temperature of 1,000° C. for 1 hour. By setting the ignition loss to 0.5 mass % or less, the particle forming a skeleton of the finally produced cerium-based abrasive can be made hard. If the ignition loss exceeds 0.5 mass %, the finally produced cerium-based abrasive has a soft skeleton and readily crushed when rubbed between a polishing pad and a material to be processed during the polishing. This phenomenon is more pronounced as the area of the glass substrate becomes larger.

On the other hand, if an excessively firm skeleton is formed, the fluorination reaction in the later production step is difficult to proceed and a high polishing rate cannot be obtained. Accordingly, in the mixed rare earth oxide of the present invention, the crystallite diameter calculated according to the Scherrer's equation from a half-value width of the maximum peak at 2θ=10 to 70 degrees in X-ray diffraction using Cu—Kα1 radiation is 200 Å or more. Also, in order to uniformly and completely perform the fluorination reaction in the later production step, the crystallite diameter is preferably 400 Å or less, more preferably 300 Å or less.

The term “ignition loss” indicates, as generally known, a percentage of mass degrease after heating of a material under the prescribed temperature condition. In the present invention, the ignition loss is an ignition loss after heating a material at a temperature of 1,000° C. for 1 hour, and is measured according to JIS-K-0067 (1992). Incidentally, this JIS standard and its English translation are easily available from the Japanese Industrial Standard Association (4-1-24, Akasaka, Minato-ku, Tokyo, Japan). The temperature condition of 1,000° C. is set by taking account of the results in thermal mass spectrometry of a mixed rare earth carbonate. More specifically, when a mixed rare earth carbonate is subjected to thermal mass spectrometry, the weight loss decreases around a temperature exceeding 500° C. and scarcely occurs at a temperature exceeding 900° C. Therefore, it is considered that substantially all the carbonate is decomposed at a temperature of 1,000° C.

The ignition loss is specifically measured as follows. The mass of a crucible set to a constant mass is measured. A dried sample is charged into the crucible and after measuring the mass, ignited for 1 hour in an electric furnace kept at 1,000° C. After ignition, the crucible is swiftly transferred into a desiccator and allowed to cool. The crucible, after being allowed to cool, is taken out from the desiccator and the mass thereof is measured. Based on the measurement results, the ignition loss is calculated according to the following formula:
B=(W1−W2)/(W1−W3)×100
(B: ignition loss (%), W1: mass (g) of sample and crucible before ignition, W2: mass (g) of sample and crucible after ignition, W3: mass (g) of crucible).

The “crystallite diameter” is measured and calculated as follows.

An X-ray diffraction analysis using Cu—Kα1 radiation is performed. Thereafter, the half-value width of the maximum peak at 2θ=10 to 70 degrees is measured, and the crystallite diameter is calculated according to the following Scherrer's equation:

Scherrer's Equation:
Dₕₖₗ=K×λ/(β×cos θ)
(Dₕₖₗ: crystallite diameter (Å, size of crystallite in the direction perpendicular to hkl), λ: wavelength of X-ray for measurement (Å), β: breadth of diffraction line due to the size of crystal (radian), θ: Bragg angle of diffraction line (radian), K: constant (differs depending on the constants of β and D)).

In general, when a half-value width β_{1/2} is used for β, this is known to give K=0.9. Also, the wavelength of Cu—Kα1 radiation is 1.54050 Å and therefore, the crystallite diameter D in the present invention is calculated according to the following formula:
D=0.9×1.54050/(β_{1/2}×cos θ)
(Mixed Rare Earth Fluoride)

The mixed rare earth fluoride of the present invention for the production of a cerium-based abrasive is a mixed fluoride of rare earths, in particular cerium (Ce), lanthanum (La), praseodymium (Pr) and neodymium (Nd), and can be produced from a natural ore (rare earth concentrate) rich in these rare earth elements.

In the mixed rare earth fluoride of the present invention, the total rare earth content is, in terms of the oxide, preferably more than about 60 mass %, more preferably on the order of 60 to 90 mass %. Also, cerium preferably occupies, in terms of the oxide, 40 mass % or more, more preferably 60 mass % or more, based on all rare earths contained. Furthermore, in the mixed rare earth fluoride of the present invention, the fluorine content is preferably from 20 to 30 mass %.

In the case of producing the mixed rare earth fluoride of the present invention from a rare earth concentrate, as described above for the mixed rare earth oxide of the present invention, a mixed rare earth compound (e.g., carbonate, hydroxide) after removing components other than rare earths, such as alkali metal, alkaline earth metal and radioactive material, from the rare earth concentrate, particularly, a mixed light rare earth compound after further chemically separating and removing middle and heavy rare earths and Nd, can be used as the raw material.

A slurry of such a mixed rare earth compound is fluorinated with a fluorine compound to cause precipitation of a mixed rare earth fluoride, and the precipitate is filtered and dried at a drying temperature of 400° C. or less, whereby the mixed rare earth fluoride of the present invention can be obtained. Examples of the fluorine compound include hydrofluoric acid, sodium fluoride and acidic ammonium fluoride. However, specific production conditions such as drying temperature and fluorine compound are dependent on the mixed rare earth compound used and should be decided to obtain the mixed rare earth fluoride of the present invention.

If the drying temperature at the time of drying the precipitate of mixed rare earth fluoride exceeds 400° C., the fluorination reaction of the mixed rare earth oxide in the process of producing a cerium-based abrasive becomes non-uniform. The non-uniform fluorination reaction may allow for formation of a hard block of mixed rare earth fluoride particles at the firing, or cause an unreacted rare earth oxide particle to remain. The hard block of mixed rare earth fluoride particles gives rise to scratches. Also, if an unreacted rare earth oxide particle remains, a high polishing rate cannot be maintained over a long period of time. Therefore, the heat-treatment temperature is preferably 400° C. or less.

For the mixed rare earth fluoride of the present invention for the production of a cerium-based abrasive, the ignition loss after heating at a temperature of 1,000° C. for 1 hour is from 3 to 15% on the dry mass basis. If this ignition loss is less than 3 mass %, the reactivity with the rare earth oxide may become worse, whereas if the ignition loss exceeds 15 mass %, the volatile components increase and this may be unprofitable.

If the maximum particle diameter of the mixed rare earth fluoride of the present invention measured by the laser diffraction/scattering method is 100 μm or more, the particle diameter is difficult to control in the grinding step and this gives rise to a non-uniform reaction with the rare earth oxide.

(Cerium-Based Abrasive)

The “cerium-based abrasive” means an abrasive containing, as the metal component, a mixture of rare earths, in particular, mainly cerium (Ce), lanthanum (La), praseodymium (Pr) and neodymium (Nd). The total rare earth content is, in terms of the oxide, preferably more than 90 mass %, more preferably about 95 mass %. Also, the cerium content is, in terms of the oxide, preferably more than 45 mass %, more preferably more than 60 mass %, based on all rare earths contained.

In the present invention, a mixed rare earth oxide and a mixed rare earth fluoride are mixed and subjected to grinding in order to produce the cerium-based abrasive, wherein at least one of the mixed rare earth oxide and the mixed rare earth fluoride to be used is the present mixed rare earth oxide or the present mixed rare earth fluoride, and preferably both of them are the present mixed rare earth oxide and the present mixed rare earth fluoride.

The above-described mixed rare earth oxide and mixed rare earth fluoride are mixed at a ratio, in terms of the mass ratio, from 90:10 to 65:35, more preferably from 85:15 to 75:25, and then ground. If the ratio of the mixed rare earth oxide exceeds 90 parts by mass, the fluorine content in the finally produced cerium-based abrasive is excessively small, and a high polishing performance may not appear. Further, if the ratio of the mixed rare earth oxide is less than 65 parts by mass, an unreacted rare earth fluoride remains in the finally produced cerium-based abrasive and becomes a hard particle to cause scratches. Here, the fluorine content is optimally from 5 to 10 mass %.

In the present invention, a dispersant may be added at the time of mixing and grinding the mixed rare earth oxide and the mixed rare earth fluoride, particularly, at the grinding in the slurry state. The mixed rare earth fluoride in particular has a strong aggregating property and therefore, when a dispersant is not added, re-aggregation may occur. If the mixed rare earth fluoride is re-aggregated, uniform fluorination of mixed rare earth oxide fine particles may not satisfactorily proceed or the polishing pad may be clogged, as a result, a high polishing performance cannot be exerted. The dispersant usable here is not particularly limited as long as it is a general dispersant capable of imparting a dispersion effect to the ground slurry, and, for example, a condensed phosphoric acid, an inorganic salt of alkali metal, or an organic salt of alkali metal may be used.

Examples of the condensed phosphoric acid include a pyrophosphoric acid; examples of the inorganic salt of alkali metal include a condensed phosphate (e.g., sodium pyrophosphate, sodium tripolyphosphate, sodium hexametaphosphate); and examples of the organic salt of alkali metal include a polystyrenesulfonate (e.g., sodium polystyrenesulfonate, potassium polystyrenesulfonate), a polycarboxylate (e.g., sodium polyacrylate, sodium polymaleate), and a naphthalenesulfonic acid formalin condensate (e.g., sodium β-napthalenesulfonate formalin condensate, sodium alkylnaphthalenesulfonate formalin condensate).

In the present invention, the average particle diameter (D50) after grinding is preferably from 0.5 to 3 μm. The average particle diameter (D50) as used herein means a particle diameter corresponding to a 50% cumulative value in the volume distribution measured with a 30-μm aperture tube by using Coulter Multisizer (manufactured by Coulter).

In the present invention, more preferably, firing at a temperature of 750 to 1,100° C. is performed after the grinding and drying. At this time, the oxygen concentration is preferably set to 10 to 20%. The optimal firing temperature varies depending on the material to be processed, the member used for polishing, the polishing condition and the like, but it is generally important to set the oxygen concentration at the firing to 10 to 20%, because the presence of oxygen is indispensable for the reaction of mixed rare earth fluoride and mixed rare earth oxide to produce a rare earth oxy-fluoride (ROF, R: rare earth element). If the oxygen concentration at the firing is less than 10%, unsatisfactory production of a rare earth oxy-fluoride results and a good polishing performance may not be easily obtained. The oxygen concentration may exceed 20%, but this is unprofitable, because an oxygen concentration higher than atmosphere does not contribute to the acceleration of reaction for producing a rare earth oxy-fluoride.

Subsequently, operations of standing to cool, cracking and classification are performed, whereby a cerium-based abrasive can be obtained. The average particle diameter (D50) of this abrasive is preferably from 0.5 to 3 μm.

(Use of Cerium-Based Abrasive)

The cerium-based abrasive of the present invention is usually handled in the powder form. On use as an abrasive, the cerium-based abrasive is generally used in the form of an aqueous liquid dispersion to accomplish finish polishing of, for example, various glass materials and glass products such as glass substrate for optical lens, glass substrate for optical disk or magnetic disk, and glass substrate for liquid crystal display.

The cerium-based abrasive of the present invention is, for example, dispersed in a dispersion medium such as water, and used in the slurry state comprising about 5 to 30 mass % of the abrasive. The dispersion medium which is preferably used in the present invention is water or a water-soluble organic solvent. Examples of the organic solvent include alcohol, polyhydric alcohol, acetone and tetrahydrofuran. Generally, water is used in many cases.

The glass substrate or the like polished by using the cerium-based abrasive of the present invention can have a polished surface with excellent quality free from generation of surface defects such as pit and scratch.

### EXAMPLES

The present invention is described in greater detail below by referring to Examples, but the present invention is not limited thereto.

### Example 1

A mixed rare earth carbonate in which the content of all rare earths was 49 mass % in terms of the oxide and, based on all rare earths contained, the cerium content was 60 mass % in terms of the oxide, the lanthanum content was 30 mass % in terms of the oxide, the praseodymium content was 7 mass % in terms of the oxide and the neodymium content was 1.5 mass % in terms of the oxide, and the content of impurities other than rare earths was 1.0 mass % or less, was prepared. Subsequently, 2 kg of this mixed rare earth carbonate was fired at a temperature of 850° C. for 2 hours in an electric furnace to obtain a mixed rare earth oxide.

The mixed rare earth oxide was then dried at a temperature of 120° C. for 2 hours and charged into a porcelain crucible set to a constant mass. Thereafter, by heating it at a temperature of 1,000° C. for 1 hour, the ignition loss was measured and found to be 0.38 mass %. Also, the crystallite diameter was calculated by using X-ray diffraction measurement, as a result, the crystallite diameter was 218 Å. The X-ray diffraction measurement was performed by using “MiniFlex” manufactured by Rigaku Corporation with a copper target and Cu—Kα1 radiation under the conditions wherein the X-ray generation voltage was 30 kV, the X-ray generation current was 15 mA, the sampling width was 0.02 degrees, and the scanning rate was 2 degrees/min.

Aside from this, hydrofluoric acid was added to the mixed rare earth carbonate slurry prepared above such that the fluorine content of the mixed rare earth fluoride became about 27 mass %. After leaving this to stand, the obtained precipitate was washed three times by a decantation process with use of deionized water, filtered, dried, heat-treated at a temperature of 350° C. for 2 hours and then ground by a hammer mill to prepare a mixed rare earth fluoride. In this mixed rare earth fluoride, the content of all rare earths was 85 mass % in terms of the oxide, the cerium content was 59 mass % in terms of the oxide based on the total rare earth content, and the fluorine content was 27 mass %. The maximum particle diameter was measured by the laser diffraction/scattering method and found to be 89 μm. Also, the mixed rare earth fluoride was dried at a temperature of 120° C. for 2 hours, and charged into a porcelain crucible set to a constant mass. Thereafter, by heating it at a temperature of 1,000° C. for 1 hour, the ignition loss was measured and found to be 8.5 mass %.

238 g of the mixed rare earth fluoride was added to 762 g of the mixed rare earth oxide, 10 g of sodium phosphate of reagent first class was added thereto. The resulting mixture was ground in a ball mill containing 600 g of deionized water to form a slurry containing powder particles of 1.5 μm. This slurry was dried, then fired at a temperature of 900° C. for 2 hours in an air having an oxygen concentration of 20% by using an electric furnace and subjected to operations of standing to cool, cracking and classification to produce a cerium-based abrasive.

Subsequently, 250 g of the obtained cerium-based abrasive was dispersed in 2,250 g of ion exchanged water to form a slurry having a concentration of 10 mass %. Using this slurry-like polishing solution, a non-alkali glass for a thin-film transistor (TFT) panel was polished, and the polished state was evaluated. The polishing conditions were as follows.

Polishing Conditions:

Polishing machine: four way-type both side polishing machine

Material processed: non-alkali glass of 5 cm×5 cm (area: 25 cm²)

Number of sheets processed: 4 sheets×6 batches

Polishing pad: polyurethane foam pad (LP-77, produced by Rhodes)

Rotation number of lower table: 60 rpm

Slurry supply rate: 60 ml/min

Work pressure: 130 g/cm²

Polishing time: 20 minutes

Incidentally, four sheets of a non-alkali glass for TFT panels for each batch were subjected to measurement of thickness before and after polishing. The thickness was measured at 4 points (portions) per sheet by a micrometer. Furthermore, for all of four sheets, the mass before and after polishing was measured by an electronic balance, and the polishing rate (μm/min) was determined as a calculated value in terms of the thickness. Also, the glass surface was observed by eye by using a halogen lamp of 200,000 lux as the light source, and the number of scratches per polished surface was determined. The center line average roughness on the glass surface was measured by using Talystep manufactured by Rank Taylor Hobson, Ltd.

The firing temperature and firing time of the mixed rare earth carbonate, the ignition loss and crystallite diameter of the mixed rare earth oxide, the drying temperature, drying time, maximum particle diameter and ignition loss of the mixed rare earth fluoride, and the mixing mass of the mixed rare earth oxide and the mixed rare earth fluoride at the production of the abrasive are shown in Table 1. Also, the average particle diameter (D50) of the abrasive, the polishing rate of 6 batches, the scratch and the surface roughness Ra are shown in Table 2.

### Example 2

A mixed rare earth oxide was obtained in the same manner as in Example 1 except that the firing temperature of the mixed rare earth carbonate was changed to 1,000° C. The ignition loss of the mixed rare earth oxide obtained was 0.12 mass %, and the crystallite diameter was 348 Å. Using this mixed rare earth oxide, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Example 3

A mixed rare earth fluoride was obtained in the same manner as in Example 1 except that the heat-treatment temperature of the mixed rare earth fluoride was changed to 400° C. The maximum particle diameter of the mixed rare earth fluoride obtained was 96 μm and the ignition loss was 3.45 mass %. Using this mixed rare earth fluoride, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Example 4

A cerium-based abrasive was obtained in the same manner as in Example 1 except that the amounts of the mixed rare earth oxide and mixed rare earth fluoride used were changed to 850 g and 150 g, respectively.

Polishing was performed by using the obtained cerium-based abrasive in the same manner as in Example 1, and the polished state was evaluated. The production conditions and the results are shown in Tables 1 and 2, respectively.

### Example 5

A mixed rare earth carbonate in which the content of all rare earths was 49 mass % in terms of the oxide and, based on all rare earths contained, the cerium content was 45 mass % in terms of the oxide, the lanthanum content was 28 mass % in terms of the oxide, the praseodymium content was 4 mass % in terms of the oxide, the neodymium content was 16 mass % in terms of the oxide and the content of other rare earth elements was 3 mass % in terms of the oxide, and the content of impurities other than rare earths was 1.5 mass % or less, was prepared. Subsequently, 2 kg of this mixed rare earth carbonate was fired at a temperature of 850° C. for 2 hours in an electric furnace to obtain a mixed rare earth oxide. The ignition loss of the mixed rare earth oxide obtained was 0.45 mass % and the crystallite diameter was 232 Å. By using this mixed rare earth oxide, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Example 6

A mixed rare earth oxide was obtained in the same manner as in Example 1 except that the firing temperature of the mixed rare earth carbonate was changed to 700° C. The ignition loss of the mixed rare earth oxide obtained was 2.35 mass % and the crystallite diameter was 124 Å. By using this mixed rare earth oxide, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Example 7

A mixed rare earth oxide was obtained in the same manner as in Example 1 except that the firing temperature of the mixed rare earth carbonate was changed to 1,300° C. The ignition loss of the mixed rare earth oxide obtained was 0.01 mass % and the crystallite diameter was 535 Å. By using this mixed rare earth oxide, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Example 8

A mixed rare earth fluoride was obtained in the same manner as in Example 1 except that the heat-treatment temperature of the mixed rare earth fluoride was changed to 800° C. The maximum particle diameter of the mixed rare earth fluoride obtained was 125 μm and the ignition loss was 1.87 mass %. By using this mixed rare earth fluoride, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Example 9

A cerium-based abrasive was obtained in the same manner as in Example 1 except that at the firing using an electric furnace after grinding and drying the mixed rare earth oxide and mixed rare earth fluoride, the oxygen concentration in the atmosphere was changed to 8%.

Polishing was performed by using the obtained cerium-based abrasive in the same manner as in Example 1, and the polished state was evaluated. The production conditions and the results are shown in Tables 1 and 2, respectively.

### Comparative Examples 1 to 3

A mixed rare earth oxide and a mixed rare earth fluoride were obtained in the same manner as in Example 1 except that the firing temperature of the mixed rare earth carbonate and the heat-treatment temperature of the mixed rare earth fluoride were changed as per shown in Table 1. An ignition loss and a crystalline diameter of the mixed rare earth oxide obtained, and a maximum particle diameter and an ignition loss of the mixed rare earth fluoride obtained are shown in Table 1. By using these mixed rare earth oxide and mixed rare earth fluoride, a cerium-based abrasive was obtained in the same manner as in Example 1.

Polishing was performed by using the obtained cerium-based abrasive in the same manner as in Example 1, and the polished state was evaluated. The production conditions and the results are shown in Tables 1 and 2, respectively.

### Comparative Example 4

A cerium-based abrasive was obtained in the same manner as in Comparative Example 1 except that at the firing using an electric furnace after the grinding and drying of the mixed rare earth oxide and mixed rare earth fluoride, an oxygen concentration of the atmosphere was changed to 8%.

Polishing was performed by using the obtained cerium-based abrasive in the same manner as in Example 1, and the polished state was evaluated. The production conditions and the results are shown in Tables 1 and 2, respectively.

TABLE 1

| | | | | | | | Mixed mass (g) at | | |
|---|---|---|---|---|---|---|---|---|---|
| | | | | | | | Production of | | Oxygen |
| | | | | Mixed Rare Earth Fluoride | | | Abrasive | | Concentration |
| | Mixed Rare Earth Oxide | | | Heat- | Maximum | | Mixed | Mixed | in |
| | Firing | Ignition | Crystallite | Treatment | Particle | Ignition | Rare | Rare | Firing |
| | Temperature | Loss | Diameter | Temperature | Diameter | Loss | Earth | Earth | Atmosphere |
| | (° C.) | (mass %) | (Å) | (° C.) | (μm) | (mass %) | Oxide | Fluoride | (%) |
| Example 1 | 850 | 0.38 | 218 | 350 | 89 | 8.5 | 762 | 238 | 20 |
| Example 2 | 1000 | 0.12 | 348 | 350 | 89 | 8.5 | 762 | 238 | 20 |
| Example 3 | 850 | 0.38 | 218 | 400 | 96 | 3.45 | 762 | 238 | 20 |
| Example 4 | 850 | 0.38 | 218 | 350 | 89 | 8.5 | 850 | 150 | 20 |
| Example 5 | 850 | 0.46 | 232 | 350 | 89 | 8.5 | 762 | 238 | 20 |
| Example 6 | 700 | 2.35 | 124 | 350 | 89 | 8.5 | 762 | 238 | 20 |
| Example 7 | 1300 | 0.01 | 535 | 350 | 89 | 8.5 | 762 | 238 | 20 |
| Example 8 | 850 | 0.38 | 218 | 800 | 125 | 1.87 | 762 | 238 | 20 |
| Example 9 | 850 | 0.38 | 218 | 350 | 89 | 8.5 | 762 | 238 | 8 |
| Comparative | 700 | 2.35 | 124 | 450 | 103 | 2.38 | 762 | 238 | 20 |
| Example 1 | | | | | | | | | |
| Comparative | 1300 | 0.01 | 535 | 450 | 103 | 2.38 | 762 | 238 | 20 |
| Example 2 | | | | | | | | | |
| Comparative | 700 | 2.35 | 124 | 800 | 125 | 1.87 | 762 | 238 | 20 |
| Example 3 | | | | | | | | | |
| Comparative | 700 | 2.35 | 124 | 450 | 103 | 2.38 | 762 | 238 | 8 |
| Example 4 | | | | | | | | | |

TABLE 2

| | Average | | | | | | | | | |
|---|---|---|---|---|---|---|---|---|---|---|
| | Particle | Polishing Rate (μm/min) | | | | | | | Scratch | Surface |
| | Diameter D50 | First | Second | Third | Fourth | Fifth | Sixth | Average | (scratches/ | Roughness Ra |
| | (μm) | Batch | Batch | Batch | Batch | Batch | Batch | Value | surface) | (Å) |
| Example 1 | 1.48 | 0.88 | 0.89 | 0.91 | 0.89 | 0.87 | 0.85 | 0.88 | 0.08 | 6.8 |
| Example 2 | 1.52 | 0.90 | 0.91 | 0.91 | 0.90 | 0.90 | 0.89 | 0.90 | 0.17 | 7.0 |
| Example 3 | 1.51 | 0.89 | 0.90 | 0.91 | 0.91 | 0.90 | 0.88 | 0.90 | 0.17 | 7.1 |
| Example 4 | 1.47 | 0.88 | 0.89 | 0.90 | 0.90 | 0.89 | 0.89 | 0.89 | 0.08 | 6.9 |
| Example 5 | 1.48 | 0.85 | 0.86 | 0.87 | 0.87 | 0.85 | 0.83 | 0.86 | 0.08 | 7.5 |
| Example 6 | 1.48 | 0.88 | 0.90 | 0.90 | 0.84 | 0.80 | 0.75 | 0.85 | 0.08 | 6.5 |
| Example 7 | 1.49 | 0.82 | 0.85 | 0.90 | 0.91 | 0.85 | 0.74 | 0.85 | 0.92 | 7.9 |
| Example 8 | 1.47 | 0.80 | 0.85 | 0.84 | 0.86 | 0.80 | 0.75 | 0.82 | 1.25 | 8.4 |
| Example 9 | 1.46 | 0.79 | 0.80 | 0.81 | 0.75 | 0.72 | 0.68 | 0.76 | 1.08 | 9.5 |
| Comparative | 1.50 | 0.80 | 0.81 | 0.78 | 0.68 | 0.59 | 0.47 | 0.69 | 0.25 | 6.9 |
| Example 1 | | | | | | | | | | |
| Comparative | 1.53 | 0.75 | 0.75 | 0.72 | 0.68 | 0.60 | 0.55 | 0.68 | 1.17 | 10.1 |
| Example 2 | | | | | | | | | | |
| Comparative | 1.48 | 0.74 | 0.75 | 0.76 | 0.70 | 0.65 | 0.60 | 0.70 | 0.92 | 9.8 |
| Example 3 | | | | | | | | | | |
| Comparative | 1.50 | 0.77 | 0.76 | 0.74 | 0.64 | 0.58 | 0.50 | 0.67 | 0.08 | 6.9 |
| Example 4 | | | | | | | | | | |

As apparent from Table 2, in the case of cerium-based abrasives of Examples 1 to 9, the polishing rate is high, the high polishing rate can be maintained over a long period of time. Particularly, in the case of the abrasives of Examples 1 to 5, the polishing rate does not decrease very much. Particularly, in the case of the abrasives of Examples 1 to 6, scratches are not generated on the surface of non-alkali glass as a material to be polished, and a good-quality polished surface with small surface roughness is obtained.

On the other hand, in the case of the cerium-based abrasive of Comparative Example 1, despite a high initial polishing rate, the high polishing rate is not kept for a long time.

In the case of the cerium-based abrasive of Comparative Examples 2 to 4, the polishing rate is low from the first batch.

Particularly, in the case of the cerium-based abrasive of Comparative Example 4, the decrease in the polishing rate is significant.

1. A mixed rare earth oxide for the production of a cerium-based abrasive, wherein the ignition loss after heating at a temperature of 1,000° C. for 1 hour is 0.5 mass % or less on the dry mass basis, and the crystallite diameter calculated from a half-value width of the maximum peak at 2θ=10 to 70 degrees in X-ray diffraction using Cu—Kα1 radiation according to the Scherrer's equation is from 200 to 400 Å.

2. The mixed rare earth oxide according to claim 1, wherein the crystallite diameter is from 200 to 300 Å.

3. A process for producing the mixed rare earth oxide according to claim 1, wherein the process comprises firing a mixed rare earth carbonate at a temperature of 850 to 1,100° C. for 1 to 10 hours.

4. A mixed rare earth fluoride for the production of a cerium-based abrasive, wherein the ignition loss after heating at a temperature of 1,000° C. for 1 hour is from 3 to 15% on the dry mass basis.

5. The mixed rare earth fluoride according to claim 4, wherein the maximum particle diameter as measured by the laser diffraction/scattering method is 100 μm or less.

6. A process for producing the mixed rare earth fluoride according to claim 4, wherein the process comprises fluorinating a mixed rare earth compound slurry with a fluorine compound to cause precipitation of a mixed rare earth fluoride and drying the precipitate at a temperature of 400° C. or less.

7. A process for producing a cerium-based abrasive, wherein the process comprises mixing the mixed rare earth oxide according to claim 1 and a mixed rare earth fluoride, and subjecting the resulted mixture to grinding, drying, firing, cracking and classification.

8. A process for producing a cerium-based abrasive, wherein the process comprises mixing a mixed rare earth oxide and the mixed rare earth fluoride according to claim 4, and subjecting the resulted mixture to grinding, drying, firing, cracking and classification.

9. A process for producing a cerium-based abrasive, wherein the process comprises mixing a mixed rare earth oxide for the production of a cerium-based abrasive, wherein the ignition loss after heating at a temperature of 1,000° C. for 1 hour is 0.5 mass % or less on the dry mass basis, and the crystallite diameter calculated from a half-value width of the maximum peak at 2θ=10 to 70 degrees in X-ray diffraction using Cu—-Kα1 radiation according to the Scherrer's equation is from 200 to 400 Å and the mixed rare earth fluoride according to claim 4, and subjecting the resulted mixture to grinding, drying, firing, cracking and classification.

10. The process for producing a cerium-based abrasive according to claim 7, wherein the mixed rare earth oxide and the mixed rare earth fluoride are mixed at a ratio of 90:10 to 65:35 in terms of the mass ratio.

11. The process for producing a cerium-based abrasive according to claim 7, wherein a dispersant is added in at least either one step of the mixing and the grinding.

12. The process for producing a cerium-based abrasive according to claim 7, wherein the firing is performed at a temperature of 750 to 1,100° C. with an oxygen concentration of 10 to 20%.

13. A cerium-based abrasive produced by using a mixed rare earth oxide for the production of a cerium-based abrasive, wherein the ignition loss after heating at a temperature of 1,000° C. for 1 hour is 0.5 mass % or less on the dry mass basis, and the crystallite diameter calculated from a half-value width of the maximum peak at 2θ=10 to 70 degrees in X-ray diffraction using Cu—Kα1 radiation according to the Scherrer's equation is from 200 to 400 Å and the mixed rare earth fluoride according to claim 4.

14. A cerium-based abrasive produced by the process according to claim 7.

15. A process for polishing a glass substrate, wherein a glass substrate is polished by using the cerium-based abrasive according to claim 13.

16. A process for producing a glass substrate, comprising a step of polishing the glass substrate by the process according to claim 15.

17. A process for producing a liquid crystal panel, a hard disk, a filter for cutting a specific-frequency wave or an optical lens, wherein the process comprises a step of polishing a glass substrate by the process according to claim 15.
